(19) United States
(12) Patent Application Publication
(10) Pub. No.: US 2011/0182700 A1
(43) Pub. Date: Jul. 28, 2011

(54) LOWER SEALING VALVE ASSEMBLY FOR A SHAFT FURNACE CHARGING INSTALLATION AND VALVE ACTUATION MECHANISM THEREFORE

(75) Inventors: Ettore Rizzuti, Bascharage (LU); Jeff Vandivinit, Dalheim (LU); Jeannot Loutsch, Mondercange (LU)

(73) Assignee: PAUL WURTH S.A., LUXEMBOURG (LU)

(21) Appl. No.: 13/058,152

(22) PCT Filed: Aug. 10, 2009
(86) PCT No.: PCT/EP2009/060343

§ 371 Date: Apr. 15, 2011

(30) Foreign Application Priority Data
Aug. 8, 2008 (LU) 91468

(51) Int. Cl. F27B 1/20; F16K 31/12

(52) U.S. Cl. 414/199; 251/12

(57) ABSTRACT

A lower sealing valve assembly for a shaft furnace charging installation including a lower sealing valve housing with a lower outlet through which charge material can freely drop onto a distribution device, the housing has at least one upper inlet for communicating with an outlet of a hopper arranged above the housing, where each inlet has an associated valve seat that is arranged inside the lower sealing valve housing and turned towards the interior of the housing, a shutter is further operatively connected to an actuation mechanism for moving the shutter into and out of sealing contact with the valve seat, the valve actuation mechanism includes a turn-slide cylindric joint having a typically vertical joint axis for swiveling the shutter in a plane perpendicular to the joint axis inside the lower sealing valve housing and for translating the shutter up and down along the joint axis such that the cylindric joint includes a shaft that is axially fixed and rotatably in a hollow sleeve, which in turn is axially slideable in an outer shell that is fixed to the housing and, further according to the invention, the mechanism includes a first hydraulic cylinder, which is connected on one side to the shell and on the other side to the hollow sleeve to impart axial translation to the sleeve and therewith to the shaft along the joint axis; and: a second hydraulic cylinder, which is hinged on one side to the sleeve and on the other side to the shaft, to impart rotation to the shaft and about the joint axis.

### TECHNICAL FIELD

The present invention generally relates to a charging installation for a shaft furnace, especially for a blast furnace, and more particularly to a lower sealing valve assembly for this type of charging installation and a valve actuation mechanism of such assembly.

### BACKGROUND

Charging installations of the Bell Less Top™ type developed by PAUL WURTH have found widespread use in blast furnaces throughout the world. In these installations, one or more hoppers, which are used for intermediate storage of charge material to be charged into the pressurized furnace, serve as a sluice or lock chamber to avoid loss of furnace pressure. To this effect, a first valve, commonly called upper sealing valve or upper seal valve, is associated to the hopper inlet and a second sealing valve, commonly called lower sealing valve or lower seal valve, is associated to the outlet of the hopper. The upper and lower valves are opened and closed in alternation as in a gas lock or sluice chamber to avoid that gas escapes through the hopper. The present invention is mainly concerned with an assembly for providing the lower sealing valve. Although particularly suitable for a BLT™ system, the proposed lower sealing valve assembly can also be used in similar competitors' systems.

International patent application WO 2007/082630 discloses two different lower sealing valve assemblies. With respect to its FIG. 4, WO 2007/082630 describes a first type of lower sealing valve assembly in a two hopper charging installation. This assembly comprises a lower sealing valve housing (32) that has a central lower outlet (125) for passing a flow of charge material (140, 142) to a distribution device (not shown) arranged below the housing (32). The housing has two upper inlets (100, 102) for receiving charge material from a respective outlet (78) of either of two hoppers (20, 22) arranged above the housing (32). In order to provide the sealing function required to avoid loss of furnace gas pressure, each upper inlet (100, 102) has an associated valve seat (118) that cooperates with a flap type valve mechanism. The flap type valve mechanism comprises two shutters in the form of flaps (116), each mounted on a first end portion of an arm (120). For each flap (116), a valve actuation mechanism (see reference sign 33 in FIG. 5) is supported by the housing (32) and operatively connected to a second end portion of the corresponding arm (120) for moving the respective flap (116) into and out of sealing contact with the associated valve seat (118) by pivoting the arm (120) about a horizontal axis located centrally in between the inlets (100, 102). A further variant of a flap type sealing valve assembly is shown in FIG. 9 of WO 2007/082630 and differs from that of FIG. 4 in that the horizontal flap axis for each inlet is provided outwardly with respect to the furnace axis. A flap type sealing valve configuration similar to FIG. 4 of WO 2007/082630 is also described in U.S. Pat. No. 3,955,693.

Flap type sealing valve arrangements as disclosed e.g. in WO 2007/082630 and U.S. Pat. No. 3,955,693 typically require a valve housing of a certain height, thereby increasing the overall height of the charging installation and related cost e.g. of the required supporting structure (e.g. blast furnace top tower) and of the conveying system for feeding the hoppers.

A different, less usual arrangement of lower sealing valves is disclosed in Japanese patent application JP 09-249905. As seen in FIG. 2(b), the lower sealing valves (60) are respectively arranged inside the separate casings (62) of the material gate valves (30) provided at the hopper outlets, i.e. outside and above the funnel-shaped collecting housing that centers the flow of charge material and passes it into the furnace throat. The lower sealing valves according to JP 09-249905 are not genuine flap type sealing valves i.e. they do not open or shut by virtue of a hinge-mounted arm that flaps. Instead, their mechanism comprises an articulated two-part arm with a forearm (26) articulated to an upper arm (27) that is rotatable about a horizontal axis (29). By virtue of the articulation in the arm, the shutter (25) supported on the forearm (26) can pivot upwards or downwards into and out of contact with the corresponding valve seat. Due to its rotatable suspension, the arm (26, 27) can rotate together with the shutter (25) about the horizontal axis (29) into and out of a parking position to the side of the material gate valve (30). The installation of JP 09-249905 would potentially allow a reduction of vertical construction height. Nonetheless, this solution has certain drawbacks, among others those of increasing design complexity and cost of the material gate valve units and rendering servicing of the latter material gate valves more cumbersome.

Russian Federation patent RU 2 040 546 discloses another sealing valve assembly for a blast furnace charging installation. Referring to the drawings of RU 2 040 546, this assembly includes a housing (1) with a seat (2) and a positioning mechanism (4) mounted in the housing by means of bearings (3). A shaft (8) with a gear wheel (7) has a lever (9) on which the shutter (10) is mounted. A rack (5) that meshes with the gear wheel (7) is coupled with the piston of a first hydraulic cylinder (6). The positioning mechanism (4) includes a second lever (11) connected to a second hydraulic cylinder (12). For tilting the shutter (10) off or onto the seat (2), the first hydraulic cylinder (6) moves the rack (5) up or down to rotate the gearwheel (7) and thereby tilt the shutter (10) on the lever (9). In order to move the shutter (10) from beneath the seat (2) into a lateral parking position and vice-versa, the second hydraulic cylinder (12) pulls or pushes the second lever (11) to rotate the entire positioning mechanism (4) inside the housing (1). Although the assembly of RU 2 040 546 aims at increased reliability, this would require additional sealing of the positioning mechanism inside the housing in order to avoid exposing the moving parts inside the housing against particle deposits. A further relatively simple sealing valve assembly for a blast furnace charging installation is proposed in USSR inventors' certificate SU 558049. With reference to the drawings of SU 558049, this assembly includes a lower sealing valve housing (1) with a lower outlet and one upper inlet with an associated valve seat (14) arranged inside the housing (1) and an additional upper hatch (2) for replacement of the shutter plate (13). The shutter plate (13) cooperates with the seat (14) and is mounted on an arm (12), which is operatively connected to a valve actuation mechanism for moving the shutter (13) into and out of sealing contact with the valve seat (14). The valve actuation mechanism comprises turn-slide cylindric joint supporting the arm (12) and thereon the shutter (13). The turn-slide joint has a shaft (4) supported axially slideable along a vertical axis for translating the shutter (13) vertically up and down by means of a first hydraulic cylinder (10). The first hydraulic cylinder (10) is connected between the upper end of the shaft (4) and a gallows-shaped bearing structure mounted on the housing (1). By virtue of the bearing structure, which has coaxial bearings (6; 8) that support bushes (6; 7) splined to the shaft (4), the shaft (4) is also rotatable about its axis for swiveling the shutter (13) in a horizontal plane, by action of a second hydraulic cylinder (9). The second hydraulic cylinder (9) is connected between the housing (1) and a lever that engages the splined shaft (4). Despite minimizing the required sealing and the required height of the housing (1), this design has not found widespread use. This may be due the rather bulky bearing structure and/or due to its design being wear- and failure-prone i.e. insufficiently reliable. Among others, since the external spline fitting on the shaft (4) and the cooperating positive-fit bush (7) on the actuation lever are designed for sliding and turning, i.e. the torque-transmitting interface is subjected to considerable wear by action of both hydraulic cylinders (9; 10). Wear may become even more pronounced, even blockage may occur, in case of non-uniform thermal expansion of the housing (1), the shaft (4) and/or the bearing structure.

### BRIEF SUMMARY

The invention provides a sealing valve assembly for a shaft furnace charging installation and, in particular, a valve-actuating mechanism therefore, which require little construction height while ensuring improved reliability.

More particularly, the present invention proposes a lower sealing valve assembly and a valve actuation mechanism. The term assembly in the present context is to mean a device comprising a number of component parts fitted together to form a functional unit.

The proposed lower sealing valve assembly for a shaft furnace charging installation comprises a lower sealing valve housing with a lower outlet through which charge material can freely pass to a distribution device such as a rotatable and pivotable chute arranged underneath the housing. The housing has at least one upper inlet for communicating with an outlet of a hopper arranged above the housing. The (or each) inlet has an associated valve seat that is, in accordance with conventional design, arranged inside the lower sealing valve housing and typically turned towards the interior of the housing. A shutter is adapted to cooperate with the valve seat and operatively connected to a valve actuation mechanism, which is preferably supported by the top plate of the lower sealing valve housing, for moving the shutter into and out of sealing contact with the valve seat. More specifically, the valve actuation mechanism comprises a turn-slide cylindric joint supporting the shutter. The cylindric joint has a joint axis, typically a substantially vertical joint axis, according to which the joint allows translating the shutter up and down, e.g. in vertical direction, and in a plane perpendicular to which the joint allows swiveling the shutter, typically in a substantially horizontal plane.

According to the invention, the turn-slide cylindric joint comprises: a shaft, acting as output shaft of the joint, an intermediate hollow sleeve, in which the shaft is mounted, and an outer shell, supporting the sleeve and forming the fixed frame of the joint. The shaft is axially fixed and rotatable about the joint axis in the hollow sleeve. The sleeve is axially slideable along the joint axis in the outer shell that is fixed to the housing. Further according to the invention the mechanism comprises: a first hydraulic cylinder for axial translation (sliding) and a second hydraulic cylinder for rotation (turning). The first cylinder has one side connected to the outer shell and the other side connected to the hollow sleeve, for axially translating the shaft with the sleeve along the joint axis relative to the shell. The second hydraulic cylinder has one side hinged to the sleeve and the other side hinged to the shaft in order to rotate the shaft relative to the intermediate sleeve about the joint axis.

One advantage of the invention resides in reducing the required construction height of the sealing valve housing. In fact, as opposed to a conventional flap valve, i.e. a valve that has a shutter that opens and shuts on an arm having one horizontally hinged side to pivot in a vertical plane, the assembly according to the invention requires considerably less vertical space for motion of the valve. Additional particular advantages of the proposed turn-slide cylindric joint reside in its reliability and its compact construction. In fact, by arranging the rotary frame of the cylindric joint as part of its sliding frame, the bearings that permit rotation are not subject to stress during translation whereas the bearings that permit translation are not subject to stress during rotation. Moreover, the proposed construction allows for a more compact arrangement, e.g. by enabling nesting of the shaft, the sleeve and the shell.

The valve actuation mechanism advantageously further comprises an extension arm, which is preferably rigid and made of one piece, having a first end portion and a second end portion with the shutter being mounted on the first end portion, preferably by means of a globe-joint, and the turn-slide cylindric joint supporting the second end portion of the extension arm.

In case the housing has a first valve seat and a second valve seat, the sealing valve assembly preferably comprises a one-sided shutter with a single sealing face that cooperates with the first valve seat and with the second valve seat. Except during motion between the seats, the shutter member will normally be in a protected position engaging either of the two seats. Hence, exposure of the shutter's sealing surface to particle deposits, especially those originating from the charge material flow through the valve housing, is considerably reduced. Preferably, the joint axis is contained in the perpendicular bisecting plane of the first and second valve seats such that the valve actuation mechanism can move the one-sided shutter out of sealing contact with the first valve seat and into sealing contact with the second valve seat and vice-versa. In order to reduce the distance between the valve seats, the joint axis of the cylindric joint can be laterally offset from the segment connecting the respective centers of the first valve seat and the second valve seat.

A preferred solution for actuation of the mechanism uses linear hydraulic actuators as follows: the first hydraulic cylinder has its cylinder barrel connected to the shell and its piston head connected to the hollow sleeve, for axially translating the hollow sleeve together with the output shaft relative to the shell along the joint axis. Similarly, in a preferred embodiment, the sleeve has a support arm attached transversely to an upper end portion of the sleeve, the output shaft has a lever arm attached transversely to an upper end portion of the output shaft. In this case, the second hydraulic cylinder preferably has its cylinder barrel hinged to the support arm and its piston head hinged to the lever arm, for rotating the output shaft relative to the sleeve about the joint axis.

In order to reduce exposure of sensitive movable parts to the severe environment of furnace gas, the outer shell is preferably fixed to the top side of the housing and arranged outside of the housing, such that most moving parts are located outside of the lower sealing valve housing. To this effect, the outer shell preferably comprises, at its lower end, a lower mounting flange for attaching the shell to the top plate of the housing.

In a further preferred configuration of the cylindric joint, the output shaft is mounted rotatable and axially fixed in the hollow sleeve by means of at least one combined radial and axial load roller bearing. The second end portion of the extension arm is preferably attached to the output shaft of the cylindric joint, e.g. by means of a splined-shaft type connection, so as to rotate and translate in unison with the output shaft.

Furthermore, the or each valve seat may have a technically horizontally oriented annular seat surface. The cylindric joint in that case correspondingly has a technically vertical joint axis.

For avoiding deposits and incrustation on the horizontally swiveling shutter, the assembly preferably further comprises a nozzle head arranged inside the lower sealing valve housing for directing a gas curtain obliquely downwards through the typically horizontal plane in which the shutter is swiveled. Such a gas curtain allows blowing off deposits from the sealing surface of the shutter.

As will be understood, the present lower sealing valve assembly is particularly suited for a blast furnace charging installation as defined herein. With the sealing valve assembly installed, the installation typically comprises one or more hoppers arranged above the lower sealing valve housing, each hopper having an outlet equipped with a material gate valve and communicating with a corresponding inlet of the lower sealing valve housing. Furthermore, a distribution device for distributing charge material inside the blast furnace is arranged below the lower outlet of the lower sealing valve for receiving and distributing the burden.

The present invention also relates to a valve actuation mechanism, which has a turn-slide cylindric joint of the configuration as proposed herein. This mechanism is specifically suited for use in a lower or upper sealing valve assembly of a shaft furnace charging installation, e.g. as initial installation equipment or as a retrofitted improvement. As will be understood, preferred embodiments of the valve actuation mechanism itself correspond to those set out above.

### BRIEF DESCRIPTION OF THE DRAWINGS

A preferred embodiment of the invention will now be described, by way of example, with reference to the accompanying drawings, in which:

FIG. 1 is perspective view of a lower sealing valve assembly in a position in which a first inlet of a sealing valve housing is sealed and a second inlet is open;

FIG. 2 is perspective view showing the assembly of FIG. 1 in an intermediate position in which a shutter is being moved from a sealing engagement at the first inlet into sealing engagement at the second inlet;

FIG. 3 is perspective view showing the assembly of FIG. 1 in a position in which the first inlet of the sealing valve housing is open and the second inlet is sealed;

FIG. 4 is a partial diagrammatic horizontal projection of the sealing valve assembly of FIGS. 1-3;

FIG. 5 is a side view of a valve seat and shutter configuration including a cooling arrangement for cooling the valve seats and the shutter and a cleaning arrangement for removing deposits from the shutter;

FIG. 6 is a top view of the valve seat and shutter configuration of FIG. 5.

Identical reference signs have been used to identify identical or similar elements throughout these drawings.

### DETAILED DESCRIPTION

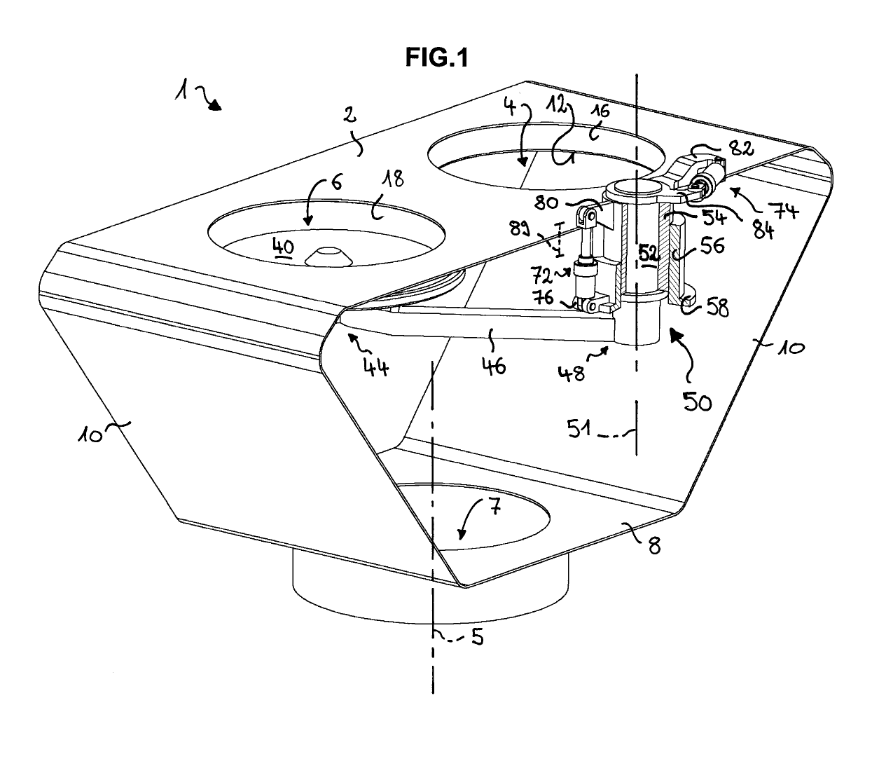

A lower sealing valve assembly as schematically shown in FIGS. 1-3 comprises a lower sealing valve housing 1. For illustration purposes, the housing 1 is shown cut open, i.e. only partially, namely without lateral portions. The housing 1 has a horizontal top plate 2 with circular openings respectively forming a first inlet 4 and a second inlet 6. The inlets 4, 6 are laterally offset with respect to the central axis 5 of the blast furnace (which is not shown) on top of which the housing 1 is arranged. A lower outlet 7 is provided coaxially on the axis 5 in the form of a circular opening in a horizontal bottom plate 8 of the housing 1. Inclined side-walls 10 connect the top plate 2 to the bottom plate 8 and confer a generally funnel-shaped configuration to the housing 1 for passing a flow of charge material entering at either of the offset inlets 4, 6 along the slanting side-walls 10 to the central outlet 7.

As will be understood, the lower sealing valve assembly as schematically shown in FIGS. 1-3 is configured for a blast furnace charging installation with two parallel hoppers (not shown). When installed on site, the housing 1 is arranged below two charge material hoppers (not shown) of a charging installation as described e.g. in WO 2007/082630 such that the upper inlets 4, 6 are connected respectively to hopper outlets (not shown) to which respective material gate valves (not shown) are associated for metering charge material. The outlet 7 of the funnel shaped housing 1 is to be arranged coaxially on top of the furnace throat (not shown) for passing charge material in free descent through the outlet 7 onto a distribution device such as, for example a rotatable and pivotable chute (not shown) of well known configuration. As will also be understood, in addition to centering the charge material flow, the housing 1 is a gas-tight enclosure that serves as a protective housing of the lower sealing valve assembly.

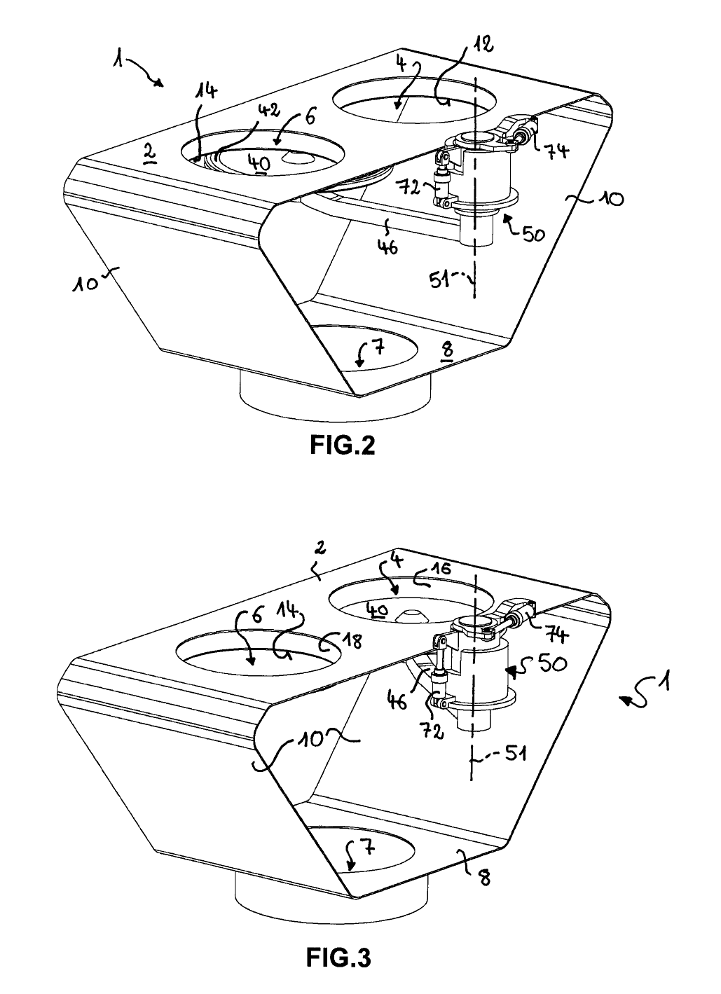

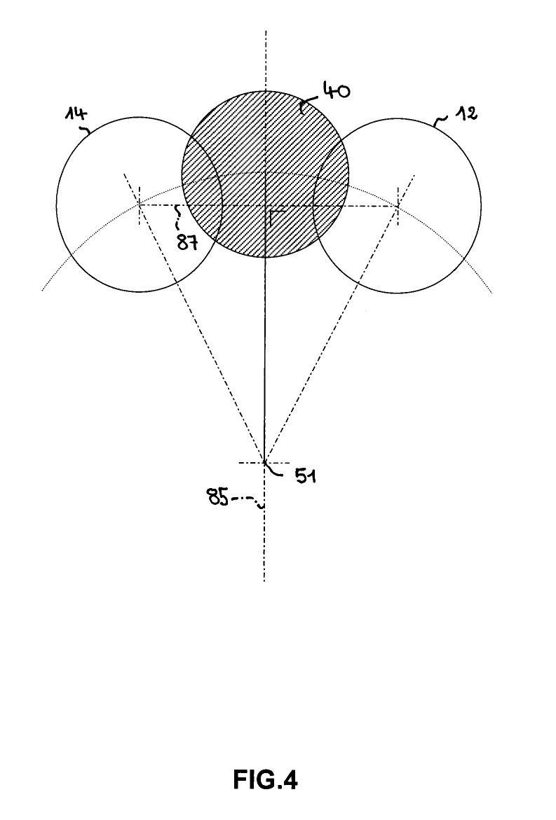

As seen in FIGS. 1-3, each inlet 4,6 has a respective associated annular valve seat 12, 14 which is turned inwards to face the interior of the housing 1 and hence accessible from below. Each valve seat 12, 14 is provided on the downward face of a cylindrical rim 16, 18 that forms an extension of the inlets 4, 6 into the housing 1. The first and second valve seats 12, 14 shown in FIGS. 1-3 have annular seat surfaces oriented horizontally. Other orientations are also possible, e.g. slightly inclined as shown in FIG. 4 of WO 2007/082630. For leak-tight closure of the inlets 4, 6, the assembly comprises a generally disk-shaped or plate-shaped shutter 40 that cooperates with both valve seats 12, 14 and is shown in sealing position on the second valve seat 14 in FIG. 1. For sealing contact, an annular sealing surface 42 (seen in FIG. 2) is provided by means of a suitable seal, e.g. a rubber gasket, on the circumference of the shutter 40. The sealing surface 42 is conjugated to the sealing surfaces of the valve seats 12, 14 for gas-tight closure by suitable sealing, e.g. rubber-metal sealing.

The shutter 40 is mounted on the tip of a first end portion 44 of an extension arm 46 by means of a globe joint (ball-and-socket joint, not shown). The globe joint warrants a circumferentially tight fit between the sealing surface 42 and the surfaces of the seats 12, 14 and allows obtaining a leak-tight seal even with orientations of the valve seats 12, 14 that differ (e.g. inclined) from exactly horizontal. The rigid extension arm 46 has a second end portion 48 rigidly attached to the output member of a turn-slide cylindric joint 50 (C-joint) which will be detailed below. As seen in FIGS. 1-3, the extension arm 46 is rigid and made of one-piece, i.e. devoid of articulations in between its end portions 44, 48.

As seen in FIGS. 1-3, the valve actuation mechanism comprises a turn-slide cylindric joint 50 that has a substantially vertical joint axis 51 and supports the extension arm 46. The cylindric joint 50 is shown in partial sectional view in FIG. 1. It is called cylindric or C-joint because trajectories traced by any point in the driven body, i.e. the arm 46 combined with the shutter 40, lie on cylinders about the joint axis 51. As will be understood, the cylindric joint 50 provides the kinematic equivalent of a revolute joint (R) combined with a prismatic joint (P) both sharing the same joint axis 51. Due to the vertical joint axis 51 of the cylindric joint 50, the rigid extension arm 46 and the shutter 40 can translate in unison up and down in a direction parallel to the joint axis 51, e.g. in substantially vertical direction. Furthermore, due the vertical joint axis 51 of the cylindric joint 50, the extension arm 46 together with the shutter 40 can swivel in a plane perpendicular to the joint axis 51, e.g. a substantially horizontal plane.

As seen in the partial sectional view of FIG. 1, the cylindric joint 50 includes an output shaft 52, i.e. a driven shaft, forming the output member of the cylindric joint 50, to which the extension arm 46 is rigidly attached so as to extend in generally horizontal direction transversely to the output shaft 52 and to the joint axis 51. The output shaft 52 forms the swivel supporting the extension arm 46 and the shutter 40. The output shaft 52 is coaxially supported in the cylindrical hollow space of a sleeve 54 in a manner fixed in axial direction and rotatable about the joint axis 51, e.g. by means of tapered roller bearings (not shown) or any other type of combined radial and axial load roller bearing. The sleeve 54 in turn is supported coaxially in the generally cylindrical hollow space of an outer shell 56 in axially slideable but rotatably fixed manner, i.e. so as to be slideable along the joint axis 51, e.g. by means of slide (plain friction) bearings. In an alternative to the cylindric joint 50 of FIG. 1, in which the rotation axis defined by the sleeve 54 and the translation axis defined by the shell 56 coincide with the joint axis 51, the parallel rotation and translation axes could be in series without necessarily being coincident. The outer shell 56 has a lower mounting flange 58. The outer shell 56 is mounted outside of the housing 1 with the mounting flange attached on top of the top plate 2 such that only the lower portion of the output shaft 52 protrudes inside the valve housing 1 through a circular opening (not shown) in the top plate 2. Consequently, except the shutter 40, the extension arm 46 and the lower end portion of the output shaft 52, all parts of the mechanism are arranged outside the housing 1 in the embodiment of FIGS. 1-3. In order to prevent gas leakage through the cylindric joint 50, seals are provided respectively between the output shaft 52 and the sleeve 54 and between the sleeve 54 and the shell 56, e.g. in form of a stuffing box or mechanical packing type seal (not shown).

As seen in FIGS. 1-3, the valve actuation mechanism includes linear hydraulic motors, namely a first hydraulic cylinder 72 and a second hydraulic cylinder 74, for operating the valve. The cylinder barrel of the first hydraulic cylinder 72 is connected by a hinge to a stationary lug 76 fixed to the lower end of the shell 56 whereas the piston head of the first hydraulic cylinder 72 is connected by a hinge to a moveable lug 80 fixed to the upper end portion of the sleeve 54. Pushing or pulling thrust of the first hydraulic cylinder 72 controls axial translation of the sleeve 54 and the output shaft 52 along the joint axis 51 and consequently also controls the upward or downward sliding motion of the shutter 40 attached to the rigid extension arm 46. The second hydraulic cylinder 74 controls rotation of the output shaft 52 relative to the sleeve 54 and the shell 56 about axis 51, i.e. horizontal swiveling of the shutter member 40 which is rigidly attached to the output shaft 52 via the extension arm 46. The second hydraulic cylinder 74 has its cylinder barrel hinged to a support arm 82 attached transversely to the upper end of the sleeve 54 and its piston head hinged to a lever arm 84 that is flange-mounted or clamped transversely to the upper end of the output shaft 52.

Referring to the diagrammatic plan view of FIG. 4, it will be appreciated that the joint axis 51 (which is perpendicular to the plane of FIG. 4) is contained in the perpendicular bisecting plane 85 (which is also perpendicular to the plane of FIG. 4) of the first and second valve seats 12, 14. More specifically, it is contained in the perpendicular bisecting plane 85 of an imaginary line segment 87 the end-points of which coincide with the centers of the valve seats 12, 14. As further seen in FIG. 4, the reach of the extension arm 46, i.e. the distance between the axis 51 and the mounting axis of the shutter 40, is equal to the distance between the centers of the valve seats 12, 14 and the joint axis 51. In other words, when the shutter 40 is swiveled horizontally, the center of the shutter 40 travels on an arc of a circle, as indicated by a dotted arc in FIG. 4, having a radius equal to this distance. Although a vertical orientation of the joint axis 51 is preferable, slight inclinations, normally in the plane 85, with respect to the vertical e.g. up to 10° are possible. The sealing valve assembly enables the use of a one-sided shutter with a single sealing face cooperating with both seats 12, 14 for alternatively sealing both inlets 4, 6. It will therefore be appreciated that, when charge material flows through the housing 1, the shutter 40 will always be in a closed position on either of the seats 12,14 and thus, especially its sealing surface 42, protected from excessive dust deposits and material impacts. Although the joint axis could theoretically be placed centrally between the valve seats 12, 14, this would require an actuation mechanism providing 180° angular swiveling motion and a certain amount of space between the seats 12, 14. Therefore, as seen in FIG. 4, the joint axis 51 is laterally offset from the line segment 87, which facilitates design of an actuation mechanism using a linear actuator for swiveling since only limited angular motion is required and allows decreasing the distance between the inlets 4, 6, e.g. to reduce outflow eccentricity downstream the lower outlet 7.

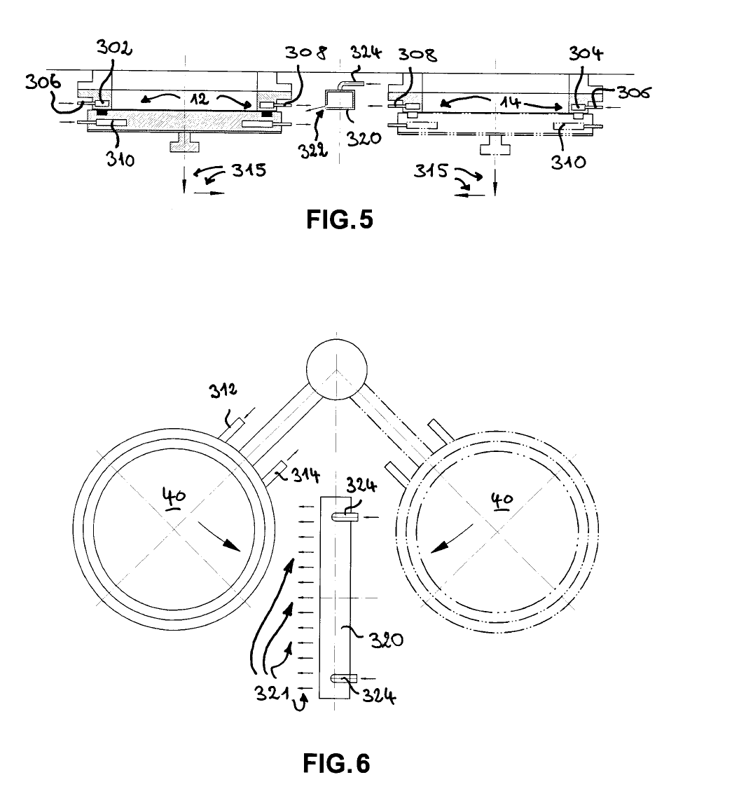

By virtue of the cylindric joint 50, the valve is operated in a lowering-swivelling-lifting motion sequence as shown from FIG. 1 to FIG. 3 (see arrows 315 in FIG. 5). FIG. 1 shows a configuration for a charging cycle using a first hopper above and communicating with the first inlet 4. When this hopper has been emptied through the first inlet 4, the second inlet 6 is to be opened for emptying a second hopper and the first inlet 4 is to be sealed for refilling the first hopper. In this case, operation of the lower sealing valve is as follows: the first hydraulic cylinder 72 is operated to contract (pull) and thereby lower the sleeve 54 and therewith, in unison, the output shaft 52, the extension arm 46 and the shutter 40, whereby the shutter 40 is disengaged from the second seat 14. Then the second hydraulic cylinder 74 is operated to expand (push) and thereby rotate the output shaft 52 about the joint axis 51 such that the extension arm 46 and the shutter 40 member swivel horizontally towards the first valve seat 12; when the shutter 40 is aligned with the first valve seat 12, e.g. due the second cylinder 74 reaching end-of-travel or due to an appropriate abutment or control, the first hydraulic cylinder 72 is operated to expand (push) and thereby lift the shutter 40 into sealing engagement with the first seat 12, as shown in FIG. 3. Operation as described above is reversed when the first inlet 4 is to be opened and the second inlet 6 is to be sealed. Due to a relatively small vertical travel 89 (compare FIGS. 1&2 or FIGS. 2&3) required for engaging/disengaging the shutter 40, the valve motion space requires only little vertical height. Hence, construction height of the housing 1 can be reduced significantly. It will further be understood, that the shutter member 40, except during its motion, will always be in a protected position on either of the seats 12, 14, when material passes through the housing 1.

Whereas the above configuration and principle of operation has been described by reference to a parallel hopper top with two hoppers, it will be understood that a comparable configuration can be used in a single central feed hopper system with only one central inlet with one associated (actual) valve seat arranged coaxially on the furnace axis, and the other seat being a pseudo-seat having no sealing function and acting merely as parking location for the shutter member.

FIGS. 5-6 show an arrangement for cooling the seats 12, 14 and the shutter 40 and a cleaning arrangement for cleaning deposits off the shutter 40. Both of the arrangements shown in FIGS. 5-6 can be used in combination, or only one of them, as needed in the embodiment described above.

The cooling arrangement for the valve seats 12, 14 shown in FIGS. 5-6 comprises a respective circumferential cooling channel 302, 304 arranged internally within the material forming the seat, 12, 14 in proximity of the actual seat surface. Each cooling channel 302, 304 has a respective inlet 306 and a respective outlet 308 connected to a coolant (e.g. water) supply and recirculation circuit (not shown) by appropriate conduits. Similarly, the disc-shaped shutter 40 comprises a circumferential cooling channel 310 having an inlet 312 and an outlet 314 connected to the coolant supply circuit. The channels 302, 304, 310 extend as internal cavities over substantially the entire circumference, except for an interruption at the location between the respective coolant inlet 306, 312 and the respective coolant outlet 308, 314 (which are schematically shown at opposite locations for illustration purposes only). The cooling arrangement of FIGS. 5-6 is particularly suitable for protecting the seals that form the sealing surface 42 and the mechanical parts even when charging hot charge material (burden) such as hot sinter through the sealing valve housing 1.

Arrows 315 in FIG. 5 also illustrate the lowering-swivelling-lifting motion sequence of the shutter 40, moving the shutter 40 from a sealing position (shown by continuous lines in FIGS. 5-6) on either seat 12, 14 into sealing position (shown by broken lines in FIGS. 5-6) on the other seat 12, 14. As is also apparent from FIG. 5 in combination with FIGS. 1-3, the shutter 40 moves in a substantially horizontal plane and requires only limited motion space in vertical direction.

FIGS. 5-6 further illustrate an arrangement for cleaning the shutter 40, i.e. for removing any deposits that may otherwise accumulate on the shutter 40 due to its substantially horizontal orientation during swiveling motion between the seats 12, 14. The cleaning arrangement comprises an elongated rectangular nozzle head 320 for forming a gas or air curtain, indicated by arrows 321 directed obliquely downwards to pass through the plane in which the shutter 40 swivels. The nozzle head 320 is formed of an elongated hollow profile that is mounted inside the housing 1 in an intermediate position between the seats 12, 14 and has a longitudinal slot 322 forming the nozzle aperture and arranged to direct the gas curtain 321 obliquely downwards onto the shutter 40 when the latter moves between the seats 12, 14. The length of the slot 322 is chosen to be greater than or at least equal to the outer diameter of the shutter 40. Gas feed inlets 324 are arranged in the top part of the nozzle head 320 for pressurizing the interior of the hollow profile. An elongated perforated baffle plate (not shown) extends inside the nozzle head 320 for uniform pressure distribution in the gas curtain 321. The inlets 324 are connected e.g. to an inert gas (e.g. nitrogen N₂) supply, as commonly available at a shaft furnace charging installation, for forming an inert gas curtain. As will be understood, by virtue of the downwardly directed, oblique gas curtain 321, any deposits on the shutter member 40 will be blown off, when the shutter member 40 passes along underneath the nozzle head 320. In order to minimize gas consumption, an actuated control valve in the gas supply line (not shown) connected to the gas feed inlets 324, may be synchronized with the operation of the actuation mechanism positioning the shutter 40, using appropriate automation measures connected to the control valve.

In conclusion, it remains to be noted that industrial application of the lower sealing valve assembly according to the present invention is possible in different configurations of shaft furnace charging installations, especially BLT™ blast furnace charging installations, examples of which are:
a parallel two-hopper top with two eccentric upper inlets in the lower sealing valve housing (as seen in FIGS. 1-3);
a parallel three hopper top with three eccentric upper inlets and a first and second valve each comprising a respective shutter on a respective extension arm connected to a respective mechanism as described hereinbefore, the shutter of the first valve cooperating with a first and a second seat for alternatively sealing the first and second eccentric inlets, the shutter of the second valve cooperating with the second and a third seat for alternatively sealing the second and third eccentric inlets;
a single hopper top with concentric (or eccentric) upper inlet in the lower sealing valve housing and, instead of a true second valve seat, an additional pseudo-seat providing a parking position according to a geometry as shown in FIG. 4.

1. A lower sealing valve assembly for a shaft furnace charging installation, said sealing valve assembly comprising:
a lower sealing valve housing having a lower outlet for passing charge material to a distribution device arranged below said housing and at least one upper inlet for receiving charge material from an outlet of a hopper arranged above said housing, said inlet having an associated valve seat inside said housing;
a shutter adapted to cooperate with said valve seat for sealing said inlet;
a valve actuation mechanism operatively connected to said shutter for moving said shutter into and out of sealing contact with said valve seat, said valve actuation mechanism comprising a turn-slide cylindric joint supporting said shutter, said cylindric joint having a joint axis, in particular a substantially vertical joint axis, for translating said shutter up and down, in particular in substantially vertical direction, and for swiveling said shutter in a plane perpendicular to said joint axis, in particular in a substantially horizontal plane;
wherein said cylindric joint comprises:
a shaft, a hollow sleeve, in which said shaft is axially fixed and rotatable about said joint axis, and an outer shell, in which said sleeve is axially slideable along said joint axis, said shell being fixed to said housing;
and wherein said mechanism comprises:
a first hydraulic cylinder, which has one side connected to said shell and the other side connected to said hollow sleeve, for axially translating said hollow sleeve and said shaft along said joint axis and relative to said shell; and
a second hydraulic cylinder, which has one side hinged to said sleeve and the other side hinged to said shaft, for rotating said shaft about said joint axis and relative to said sleeve.

2. The sealing valve assembly according to claim 1, wherein said valve actuation mechanism further comprises an extension arm, in particular a rigid one-piece extension arm, having a first end portion and a second end portion, said shutter being mounted on said first end portion of said extension arm, in particular by means of a globe joint, and wherein said shaft of said turn-slide cylindric joint supports said extension arm at said second end portion for translating said extension arm with said shutter up and down and swiveling said extension arm with said shutter in a plane perpendicular to said joint axis.

3. The sealing valve assembly according to claim 1, wherein said first hydraulic cylinder has a cylinder barrel connected to said shell and a piston head connected to said hollow sleeve for axially translating said hollow sleeve and said shaft relative to said shell and along said joint axis.

4. The sealing valve assembly according to claim 3, wherein said sleeve has a support arm attached transversely to an upper end portion of said sleeve, said shaft has a lever arm attached transversely to an upper end portion of said shaft and said second hydraulic cylinder has a cylinder barrel hinged to said support arm and a piston head hinged to said lever arm for rotating said shaft relative to said sleeve about said joint axis.

5. The sealing valve assembly according to claim 1, wherein said outer shell is fixed to the top side of said housing and arranged outside of said housing.

6. The sealing valve assembly according to claim 1, wherein said outer shell has a lower mounting flange for attaching said outer shell on a top plate of said housing so that said valve actuation mechanism is supported by the top plate of said housing.

7. The sealing valve assembly according to claim 1, wherein said shaft is mounted rotatable and axially fixed in said hollow sleeve by means of at least one combined radial and axial load roller bearing.

8. The sealing valve assembly according to claim 1, wherein said housing has a first valve seat and a second valve seat and wherein said sealing valve assembly comprises a one-sided shutter with a single sealing face that cooperates with said first valve seat and with said second valve seat.

9. The sealing valve assembly according to claim 1, wherein said housing has a first valve seat and a second valve seat and wherein said valve actuation mechanism is supported by said housing with said joint axis being contained in the perpendicular bisecting plane of said first and second valve seats, in particular with said substantially vertical joint axis arranged laterally offset from the segment connecting the respective centers of said first valve seat and said second valve seat, such that said valve actuation mechanism can move said one-sided shutter out of sealing contact with said first valve seat and into sealing contact with said second valve seat and vice-versa.

10. The sealing valve assembly according to claim 1, wherein said or each valve seat has an annular horizontally oriented seat surface and said cylindric joint has a vertical joint axis.

11. The sealing valve assembly according to claim 3, wherein said second end portion of said extension arm is attached to said shaft of said cylindric joint so as to rotate and translate in unison with said shaft.

12. The sealing valve assembly according to claim 1, further comprising a nozzle head arranged inside said lower sealing valve housing for directing a gas curtain obliquely downwards through said plane in which said shutter is swiveled.

13. A blast furnace charging installation comprising a lower sealing valve assembly according to claim 1, said installation comprising at least one a hopper arranged above said lower sealing valve housing, said hopper having an outlet equipped with a material gate valve and communicating with an inlet of said lower sealing valve housing and a distribution device for distributing charge material inside said blast furnace, said distribution device being arranged below said lower outlet of said lower sealing valve.

14. A valve actuation mechanism for a sealing valve assembly of shaft furnace charging installation, said valve actuation mechanism being configured for moving a shutter into and out of sealing contact with a valve seat, said valve actuation mechanism comprising
a turn-slide cylindric joint for supporting said shutter, said cylindric joint having a joint axis, in particular a substantially vertical joint axis, and for translating said shutter up and down, in particular in substantially vertical direction, and swiveling said shutter in a plane perpendicular to said joint axis, in particular in a substantially horizontal plane;
wherein said cylindric joint comprises:
a shaft, a hollow sleeve, in which said shaft is axially fixed and rotatable about said joint axis, and an outer shell, in which said sleeve is axially slideable along said joint axis, said shell being fixed to said housing;
and wherein said mechanism further comprises:
a first hydraulic cylinder, which has one side connected to said shell and the other side connected to said hollow sleeve, for axially translating said hollow sleeve and said shaft along said joint axis and relative to said shell; and
a second hydraulic cylinder, which has one side hinged to said sleeve and the other side hinged to said shaft, for rotating said shaft relative to said sleeve about said joint axis.
